(19) United States
(12) Patent Application Publication
(10) Pub. No.: US 2011/0139269 A1
(43) Pub. Date: Jun. 16, 2011

(54) Water Retention and Recycling System

(76) Inventor: Spencer Dean Rogers, Orange, CA (US)

(21) Appl. No.: 12/942,960

(22) Filed: Nov. 9, 2010

Related U.S. Application Data
(60) Provisional application No. 61/280,849, filed on Nov. 10, 2009.
(60) Provisional application No. 61/455,237, filed on Oct. 18, 2010.

(51) Int. Cl. F16K 49/00

(52) U.S. Cl. 137/339

(57) ABSTRACT

In one embodiment a method and apparatus is provided that prevents water waste that commonly occurs while one is are waiting for hot water to arrive at a shower head or other hot water source. The embodiment saves the water that would go down the drain while waiting for the hot water to arrive from the water heating unit by capturing the cold/warm water and adding it back to the shower water.

This application claims the benefit of U.S. Provisional Application Nos. 61/280,849, filed Nov. 9, 2009, and 61/455,237, filed Oct. 18, 2010, both of which are incorporated herein by reference in their entirety.

As set forth herein in one embodiment referred to as the Shower Revolution (or Smart Shower), a method and apparatus is provided that prevents water waste that commonly occurs while one is are waiting for hot water to arrive at the shower head from the hot water dispenser. The embodiment saves all of the water that would go down the drain while waiting for the hot water to arrive from the water heating unit. The Shower Revolution captures cold water and a small amount of hot water then adds it back to the shower head or other water dispensers.

Some embodiments of the Shower Revolution provide a means of conserving water that is easy to install and operate. This solution offers a low start cost as well as a low operating cost relative to other solutions currently offered in the marketplace. The concept is based on capturing cold water between the hot water heater and the shower head and recycling the cold water and recombining it with hot water thereby eliminating the waste of running water until the water becomes hot.

Water conservation has been a focus of government since the beginning of civilization. There currently exists a wide range of concepts and products. Generally the products rely on an installation by a professional such as a plumber or contractor. The costs of the current solutions reflect the complexity and difficulty of the implementation. Additionally, the other solutions are tied into an ongoing energy cost because they are focused more on instant hot water than on water and energy savings.

Some embodiments of the Shower Revolution are focused on three basic goals; reduced water usage, ease of implementation and use, and nominal ongoing usage cost. Using Shower Revolution the average household of 4 can save on average 5,000 gallons of water per year minimum and up. The Shower Revolution can be installed by an untrained individual in less than one hour—a major benefit possible because the Shower Revolution can be installed without the need to change the existing plumbing configuration and there is no need for a professional plumber or a permit. There is no overall additional energy usage, because there is a significant energy saving to the water district based on the reduction of purification and sewer treatment demands. The Shower Revolution can provide significant, measurable benefits to individual users and the community as a whole.

Other features and advantages of some embodiments of the present invention will become apparent from the following detailed description. It should be understood, however, that the detailed description and the specific examples, while indicating the preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

FIG. 1 shows an electrical and plumbing implementation of an embodiment of the invention.

FIG. 2 shows a side view of a shower head according various embodiments.

FIG. 3 shows a dynamo/generator charging system that can be used with various embodiments.

FIG. 4 shows an electrical diagram according to various embodiments.

FIG. 5 shows liquid holders and dispensers that can be used with various embodiments.

FIGS. 6 A and B show the loading and unloading of the liquid holders of FIG. 5.

FIG. 7 shows alternate features of some embodiments.

FIG. 8 shows alternate embodiments having both a mirror and a display screen.

FIGS. 9-12 show various valve configurations for returning water from the bladder to the shower head or line.

### DETAILED DESCRIPTION

The following description is intended to illustrate various embodiments of the invention. As such, the specific modifications discussed are not to be construed as limitations on the scope of the invention. It will be apparent to one skilled in the art that various equivalents, changes, and modifications may be made without departing from the scope of the invention, and it is understood that such equivalent embodiments are to be included herein.

In one embodiment the system is installed by removing the existing shower head and stem and replacing it with a new stem that has a quick release attachment that connects to the system. The system is mounted around the quick release stem and a hinged adhesive frame that holds the system to the shower wall. One of many added features of the system is the availability to adjust the shower head height. Such as system can be considered a retrofit system. In other embodiments the system can be installed during construction of the shower or other hot water dispenser. It will be understood that various features set forth herein can be used or omitted with either the retrofit or new construction/remodel system.

In another aspect, the system can also include the availability to have bath products mixed with the water on demand (at the push of a button). Other features and options include a shaving mirror, a television, a stereo music system, adjustable shelving, iPod docking station, upgraded material, lighting, and color and material matching with the existing shower.

In various aspects, the Shower Revolution may be implemented in an electrical or manual manner.

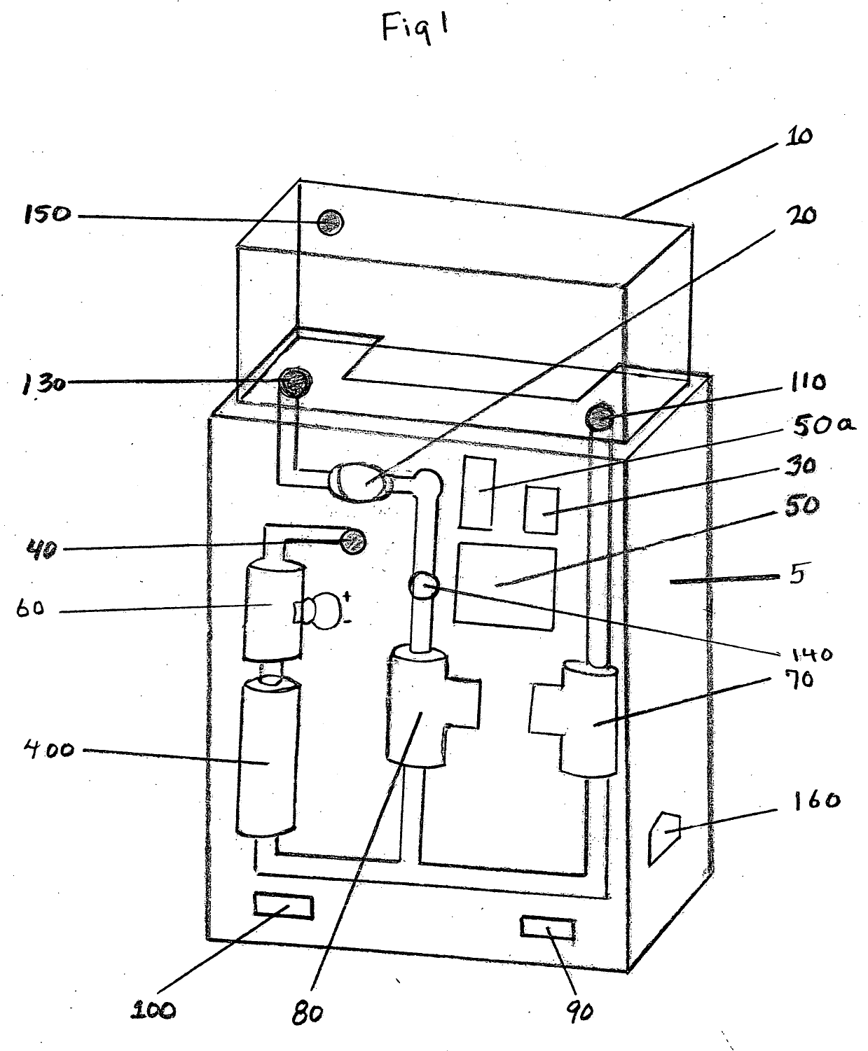

In one embodiment the Shower Revolution is implemented in an electrical manner. Referring to FIG. 1, the Shower Revolution can include an outer housing 5 including one or more of a bladder (or a coil) 10, one or more one way valve(s) 20, a timer 30, a water source 40, a battery 50, a generator/dynamo 60, a varying wattage and voltage, and an in-line water softener 400, a first solenoid 70, a second solenoid 80, a first switch 90, a second switch 100, and a diverter valve for a hand held wand 140, and a micro-biotic air filter for venting which may or may not be used 150, and in addition a battery receiver for additional low voltage power supply of multiple wattages and voltages, 160.

The Shower Revolution is engaged by pushing the first switch 90. A user will then turn on the hot water to the shower in the usual manner. Cold water from the hot water line is thereby diverted into the bladder 10 above the shower head at 110 and returned back to the shower head through 120.

First switch 90 and solenoid 70 can be coupled to a timer and/or thermostat that can be adjusted to shut off the solenoid 70 which in turn causes the Shower Revolution to stop diverting water from the hot water line to the bladder at any amount of water up to the capacity of the various sizes of bladders 10. In one aspect the timer and or thermostat can include a notification signal, such as a beep, that notifies the user that the shower is ready.

The user now turns on the water and adjusts the valves as usual to the desired temperature and thereafter can generally be run by switches 90 and 100 with minor temperature adjustments though primary valves as needed.

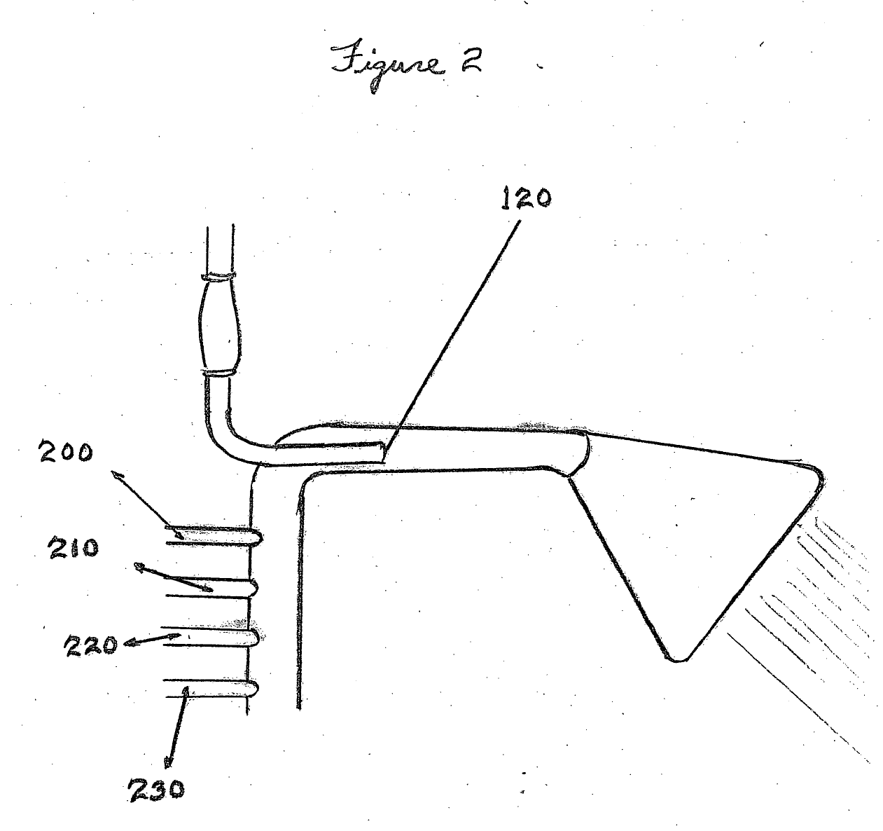

Referring to FIG. 2, now that the shower is running, the water in the bladder 10 can be added back to the shower by, for example, entering the water line before the shower head, or into the shower head directly, by a line 120 coming from the bladder 10. In another aspect, as the water in the bladder 10 is added back to the shower head the timer/thermostat can allow a small amount of hot water to continue to flow into the bladder 10, such that a mixture of the cold water in the bladder 10 and hot water results in warm water added back to the shower head.

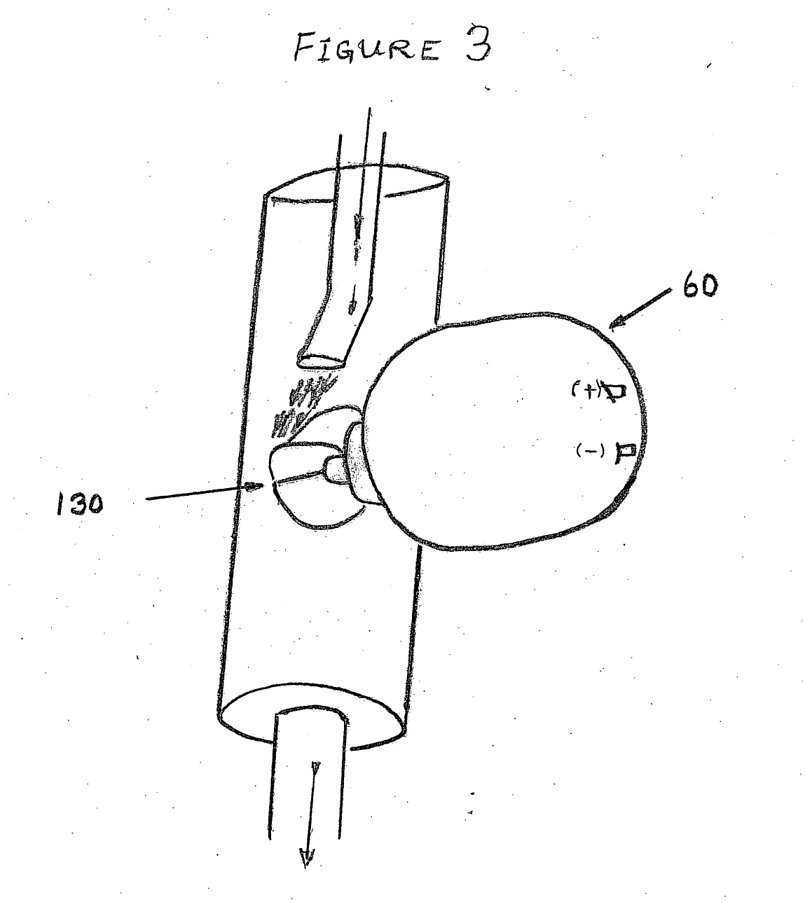

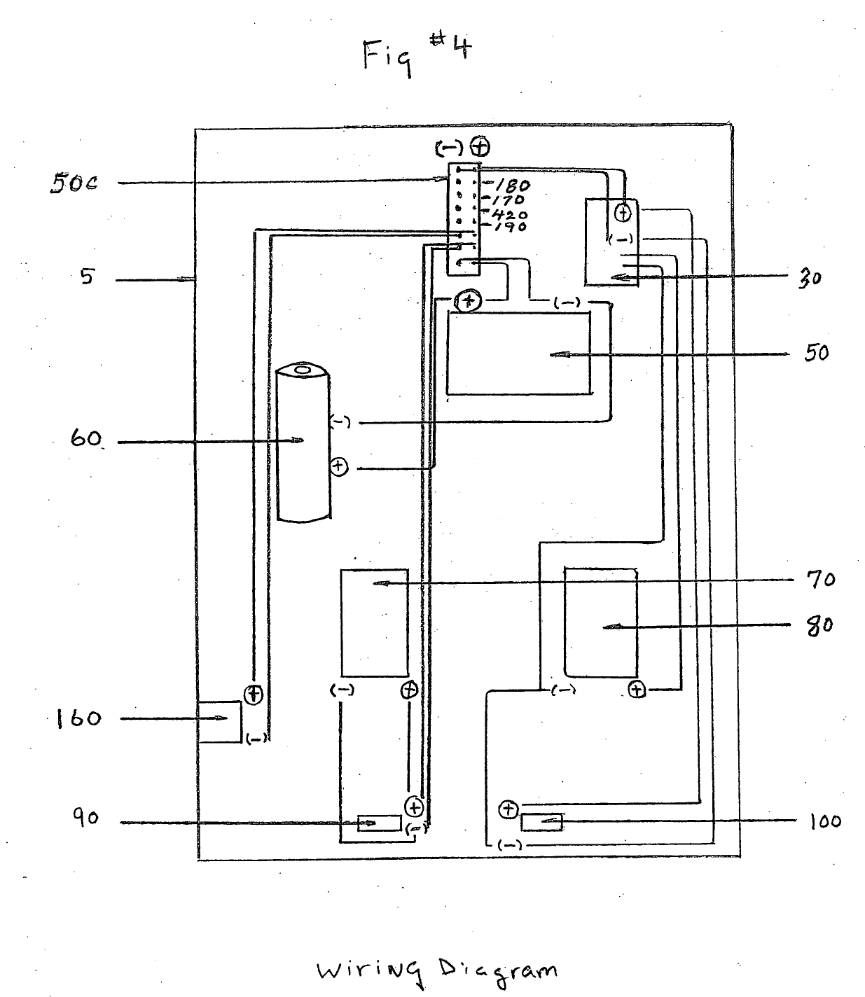

Referring to FIGS. 1 and 3, in another aspect, a dynamo/generator charging system can be included. The generator/dynamo 60 can be located after the water source (where the shower revolution connects to the existing shower head plumbing, line 40). The water pressure in the water line spins a fin water wheel 130 attached to the dynamo/generator 60 which in turn charges the battery 50. The battery 50 can be used to power any aspect of the Shower Revolution. For example, referring to FIG. 4, a power system is used to power 2 switches, a timer with the connections to the power bar 50a, 2 solenoids, and could be used with other optional features including, but not limited to: radio 180, CD player, DVD player 190, and lights 170 for a mirror 420a. The power system could be of varying voltage and wattage, between 12, 18, and 24 volts as shown in FIG. 4, an alternate power source could be provided though an external battery receiver 160. Alternatively, other power sources could be provided including other backup batteries, solar or other low voltage power charging systems.

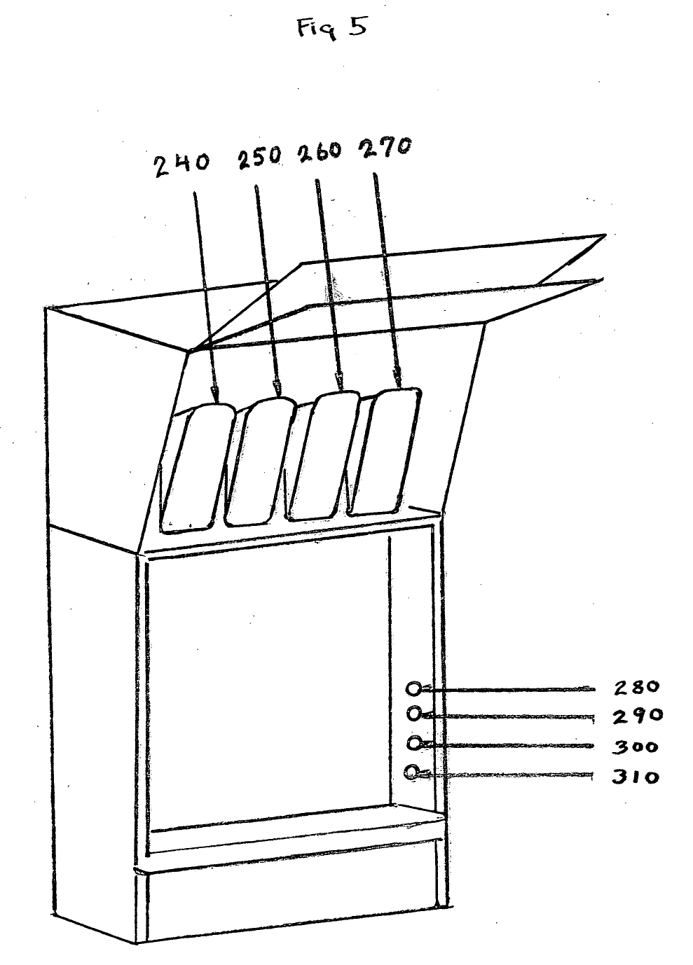

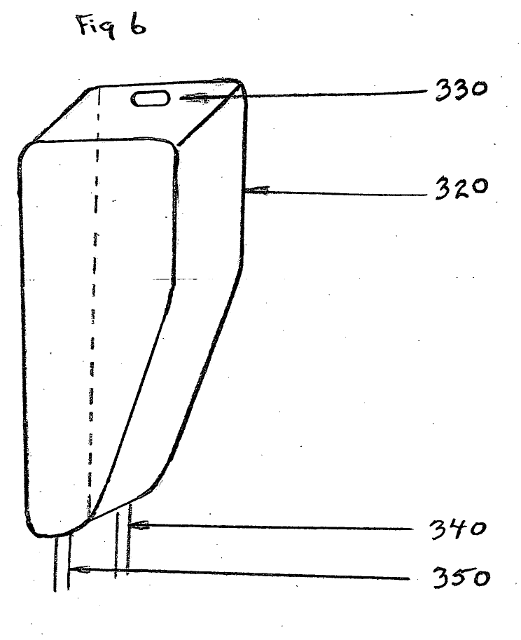

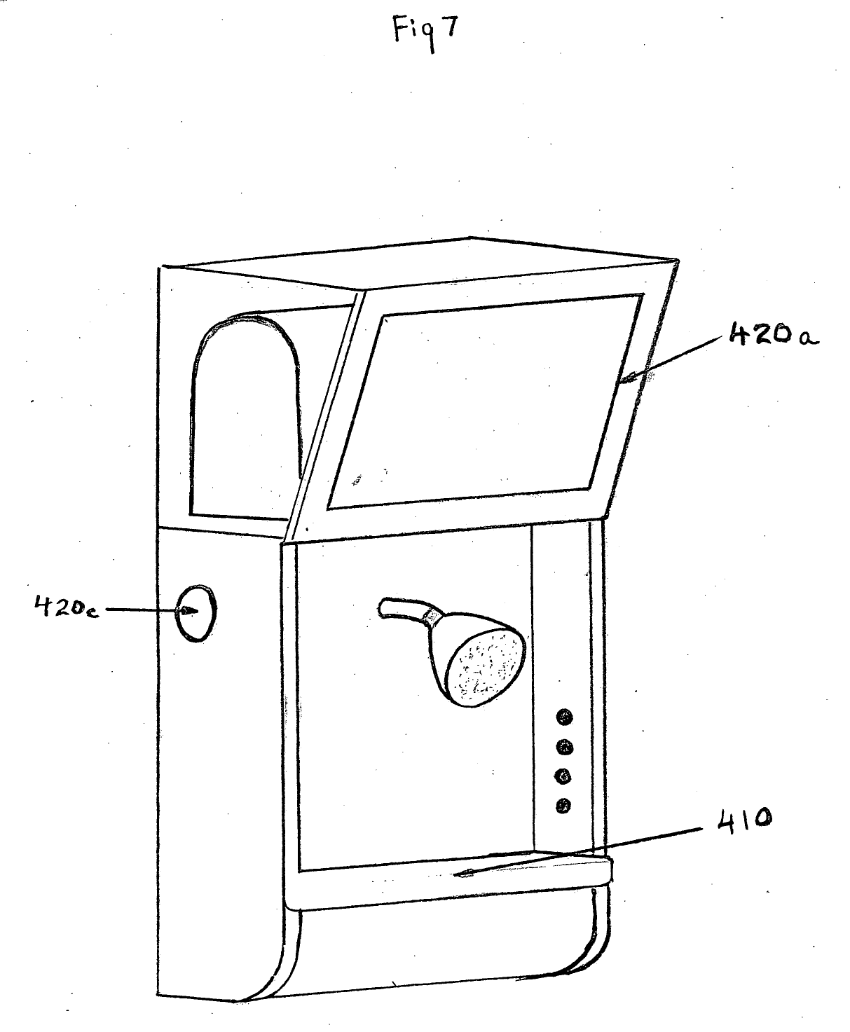

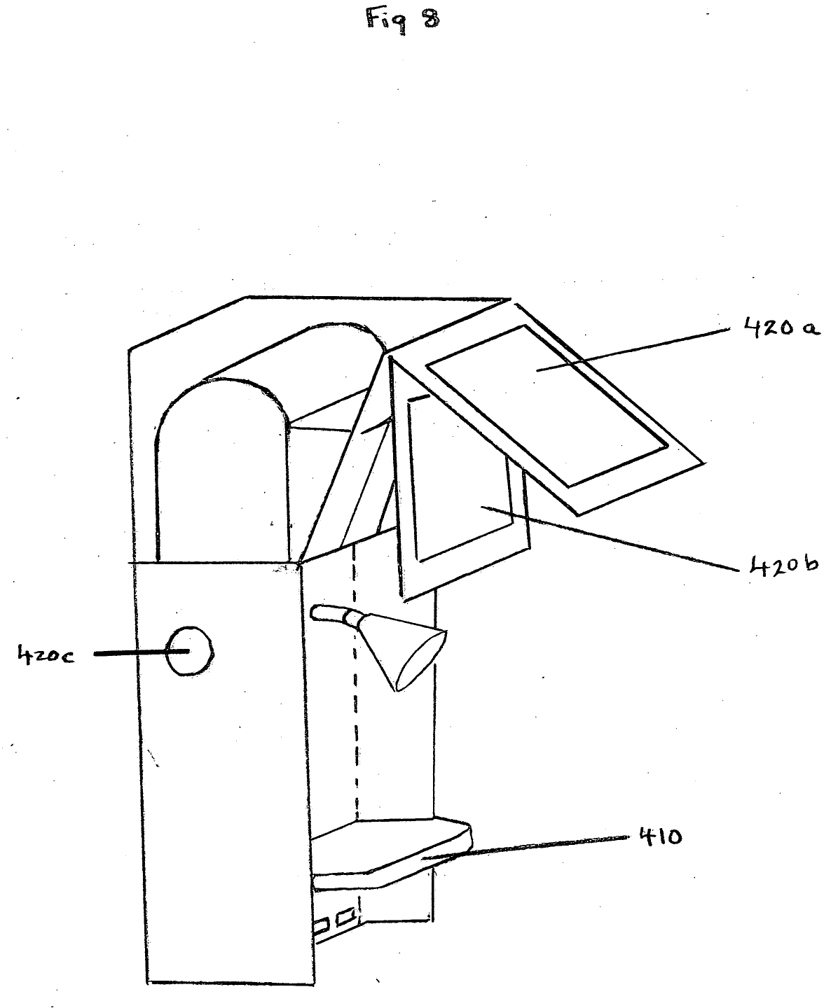

Referring to FIG. 2, in another aspect shower products can be added to the shower water at or before the shower head through ports 200, 210, 220, and 230. Referring to FIG. 5, the shower products can be held in Type III plastic liquid holders 240, 250, 260, and 270 for addition to the hand or shower water. In another aspect, the shower products can be loaded and unloaded in a vertical manner for addition to hand or shower water dispensed by a user through dispensers 280, 290, 300, 310. Referring to FIG. 6A, a single Type I, II or III plastic container showing the Body 320 the container vent 330 also the line dispenser to the shower head 340 or the line dispenser into the bathers hand 350.

The multiple use container being made of 1 or a combination of materials such as Types I, II, & III, plastics, foam, acrylic fiberglass, natural stone, tile, carbon fiber, and possibly any of the many other structural materials available. Several of the possible material can be printed w/laser jet matching any marble, granite, tile, or a picture of whatever the customer choose and can include other features for a user including one or more speakers 420c, shelves 410 optionally made of matching material such as natural stone or tile, can also include both a mirror 420a and a digital display 420b.

In another aspect, a manual system and method of operation is described. The manual method and system is similar to the electric method and system. Manual valves can replace one or more of the switches 90, 100 and solenoids 70, and 80, set forth above. The system can be turned on by a spring valve in place of solenoid 70 located at the bottom of the housing. This adjustable spring valve can control the volume of cold and hot water being dispensed into the bladder 10.

When the spring valve shuts off, a bell will sound notifying the bather that the shower is ready. Alternatively, the user could manually shut the spring valve off. A second manual valve used in place of solenoid 80 can control the shower head after the Shower Revolution is ready. The bather turns on that second valve and adjusts the water temperature as usual.

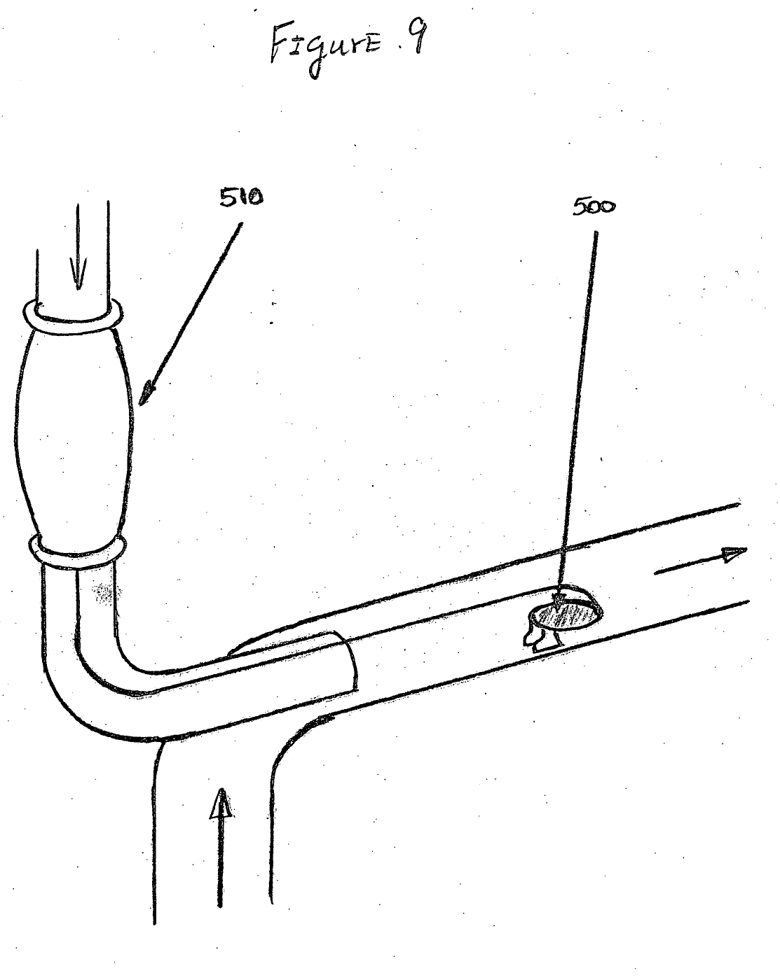

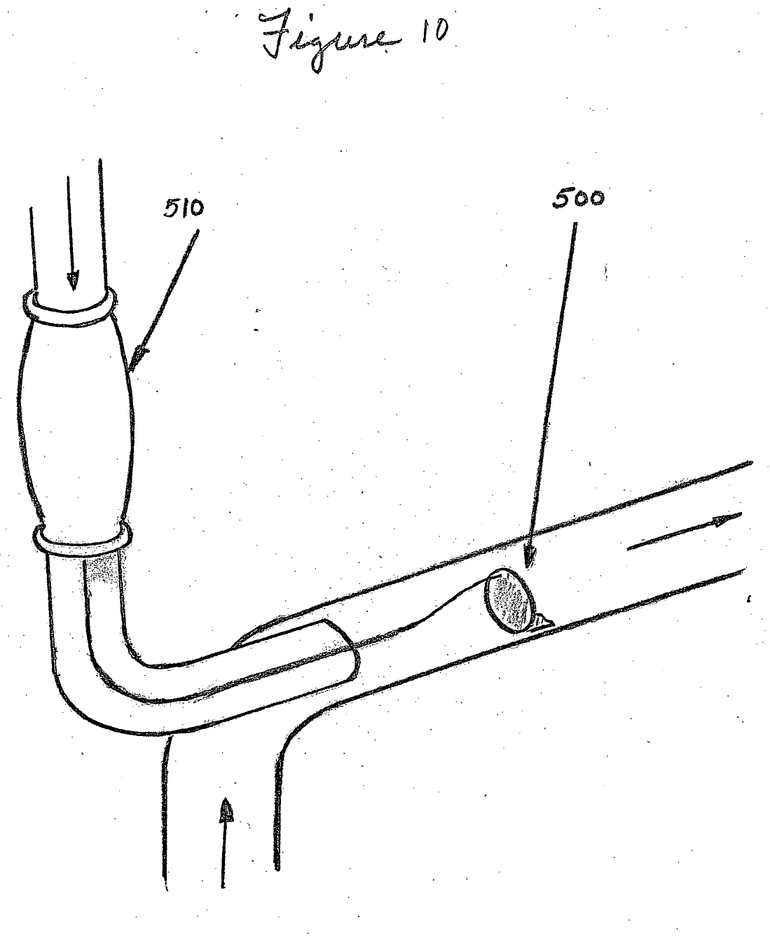

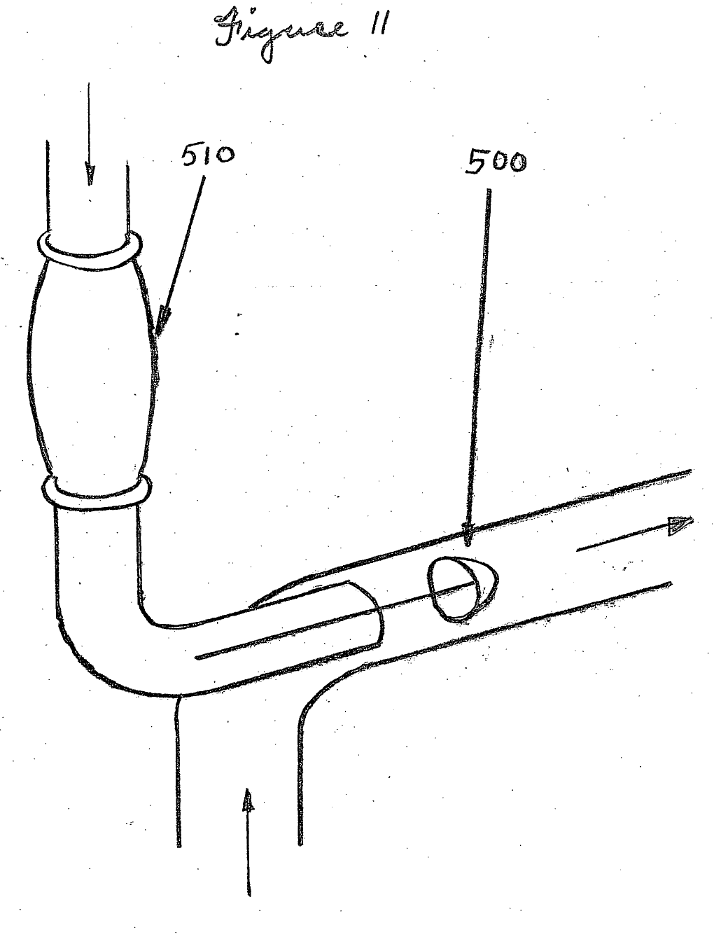

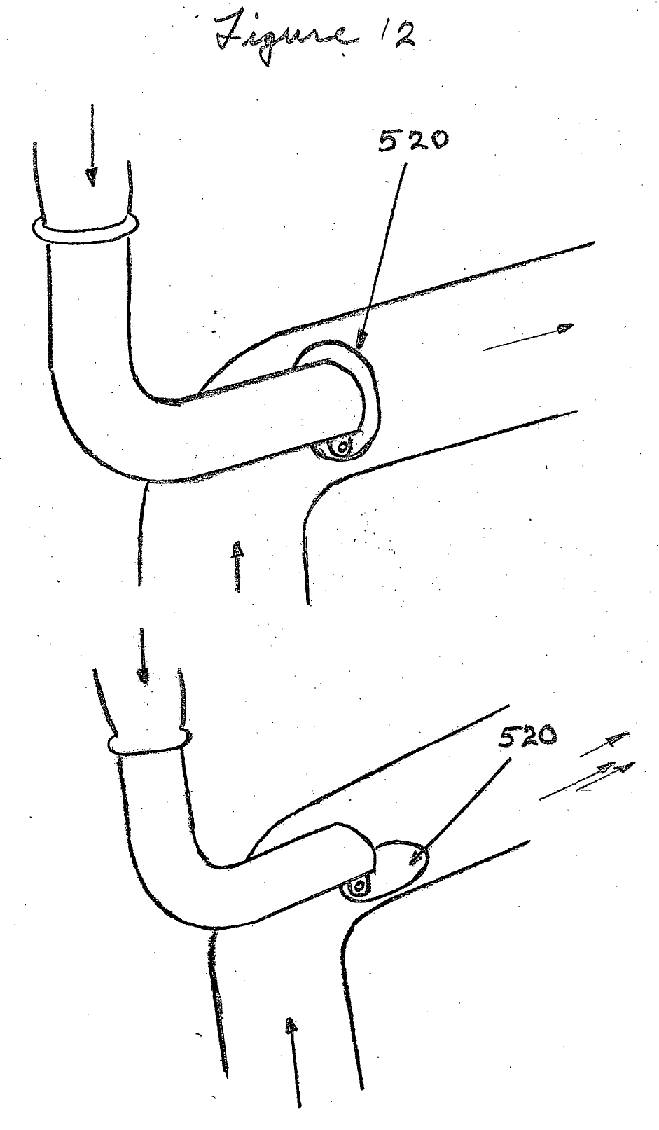

In another aspect, with the shower running, the water in the bladder 10 can be added back to the shower as set forth above. Referring to FIGS. 9-12, now that the shower is running, the water pressure can open a valve 500 or similar which triggers the one way valve 510 at the end of the bladder 10. Referring to FIGS. 9 and 10 the open and closed positions of the valve 500 are shown. Referring to FIG. 11 an alternative configuration for the valve 500 is shown. Referring to FIGS. 12 A and B, a one way valve 520 is shown having an alternate configuration. Upon opening of the one way valve 510 or the one way valve 520, cold or warm water in the bladder 10 slowly mixes with water in route to the shower head until the bladder 10 is empty.

In another embodiment this coil system stores all of the cold water that is in the hot water line when the adjustable spring valve opens and closes to whatever length of time is set on the spring valve timer/thermostat then closes, separating the other end of the coil is a one-way valve where the coil is connected to the cold water line. When the cold water is turned on the one way valve is opened that pulls the stored water into the main cold water line 2 or more one way valves may be used, micro-biotic air filters. A very similar operation as [0024] also where the above description of items may also or may not be needed. The alternative embodiment can be in a retrofit and/or a new construction configuration.

In another aspect, embodiments herein could be used to soften the water by, for example providing a conventional water softener system inside the multi-use container, or adding water softener or shower salts to the bladder or coil through FIG. 2 page 13 and FIG. 6 page 17's method of infusion

Although the invention has been described with respect to specific embodiments and examples, it will be readily appreciated by those skilled in the art that modifications and adaptations of the invention are possible without deviation from the spirit and scope of the invention. Accordingly, the scope of the present invention is limited only by the following claims.

### Index

| | |
|---|---|
| 5 | Multi-Use Container |
| 10 | Bladder/Coil |
| 20 | One way valve |
| 30 | Timer |
| 40 | Water Source |
| 50 | Battery |
| 60 | Generator |
| 70 | First Solenoid |
| 80 | Second Solenoid |
| 90 | First Switch |
| 100 | Second Switch |
| 110 | Bladder Water Inlet |
| 120 | Return Line |
| 50a | Power Bar |
| 130 | Water Fin |
| 140 | Diverter Valve |
| 150 | Vent |
| 160 | Additional Power Receiver |
| 170 | Lights for Mirror |
| 180 | Radio |
| 190 | DVD Player |
| 200 | Soap Ports |
| 210 | Soap Ports |
| 220 | Soap Ports |
| 230 | Soap Ports |
| 240 | Plastic Liquid Holders |
| 250 | Plastic Liquid Holders |
| 260 | Plastic Liquid Holders |
| 270 | Plastic Liquid Holders |
| 280 | Dispensers |
| 290 | Dispensers |
| 300 | Dispensers |
| 310 | Dispensers |
| 320 | Product Containers |
| 330 | Product Containers |
| 340 | Product Containers |
| 350 | Product Containers |
| 400 | Water Softener |
| 410 | Granite Shelf |
| 420a | Mirror |
| 420b | Digital Display |
| 420c | Speakers |
| 500 | Valve |
| 510 | One way Valve |
| 520 | One way valve |

1. A system for conserving water while a user waits for hot water in a shower, the system comprising:
a water retention space coupled to water line, the water line for delivery of water to a shower head;
a diverter configured to divert water intended to flow through the shower head to the water retention space;
a return line configured to deliver the diverted water back to the shower head after the diverted water is mixed with water from the water line.

2. The system of claim 1 further comprising a switch for engaging the diverter.

3. The system of claim 2 further comprising a second switch for disengaging the diverter.

4. The system of claim 3 further comprising a sensor for sensing the amount of water in the water retention space.

5. The system of claim 4 further comprising a sensor for sensing the temperature of the water in the water line.

6. The system of claim 5 further comprising a water additive container coupled to water line for delivery of additives to the shower water.

7. The system of claim 1 further comprising an entertainment device.

8. The system of claim 7 wherein the entertainment device is a radio, CD player, DVD player or video screen.

9. The system of claim 8 further comprising a mirror.

10. The system of claim 1 further comprising a generator coupled to the water line to generate electricity.

11. The system of claim 1 further comprising an indicator to indicate to a use that the shower is ready for use.

12. A system for conserving water while a user waits for hot water at a shower, bath tub and/or sink. The system comprising of: the system of claim 1, wherein the system is configured to retrofit an existing shower by insertion of the system between the hot water heater and the shower head.

13. The system of claim 12, wherein the water retention space is configured to retain at least the amount of cold water held in the hot water line between a hot water source and the shower head, plus enough hot water to warm the system.

14. The system of claim 13 wherein the water retention space comprises a closed or vented bladder.

15. The system of claim 13 wherein the water retention space coil closed or vented.

16. That in the system there is an in-line water softener.
